(19) United States
(12) Patent Application Publication
(10) Pub. No.: US 2018/0324688 A1
(43) Pub. Date: Nov. 8, 2018

(54) RESOURCE SHARING BETWEEN PDCCH AND PDSCH

(71) Applicant: Mediatek Inc., Hsin-Chu (TW)

(72) Inventors: Chien-Chang Li, Hsinchu (TW); Yiju Liao, Hsinchu (TW); Chien Hwa Hwang, Hsinchu (TW); Pei-Kai Liao, Hsinchu (TW)

(21) Appl. No.: 15/969,982

(22) Filed: May 3, 2018

Related U.S. Application Data
(60) Provisional application No. 62/501,945, filed on May 5, 2017.

(51) Int. Cl. H04W 48/16; H04W 72/04; H04W 72/12

(52) U.S. Cl. CPC H04W 48/16; H04L 5/0007; H04W 72/1205; H04W 72/042

(57) ABSTRACT

In an aspect of the disclosure, a method, a computer-readable medium, and an apparatus are provided. The apparatus may be a UE. In accordance with the method, the UE receives symbols in a time slot. The time slot includes a control region and a data region. The UE further determines a down link data channel specific to the UE carried by the received symbols in the data region. The down link data channel is provided on at least one range of frequencies. The UE further determines that one or more of the received symbols on the at least one range of frequencies and in the control region are a part of the down link data channel.

### CROSS-REFERENCE TO RELATED APPLICATION(S)

This application claims the benefit of U.S. Provisional Application Ser. No. 62/501,945 Filed May 5, 2017, entitled “RESOURCE SHARING BETWEEN PDCCH AND PDSCH,” which is expressly incorporated by reference herein in its entirety.

### BACKGROUND

### Field

The present disclosure relates generally to communication systems, and more particularly, to user equipment (UE) that process transmissions that share resources between PDCCH and PDSCH.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE of a wireless communication system. The UE receives symbols in a time slot, the time slot including a control region and a data region. The UE determines a down link data channel specific to the UE carried by the received symbols in the data region. The down link data channel is on at least one range of frequencies. The UE determines that one or more of the received symbols on the at least one range of frequencies and in the control region are a part of the down link data channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating a base station in communication with a UE in an access network.

FIG. 4 illustrates an example logical architecture of a distributed access network.

FIG. 5 illustrates an example physical architecture of a distributed access network.

FIG. 6 is a diagram showing an example of a DL-centric subframe.

FIG. 7 is a diagram showing an example of an UL-centric subframe.

FIG. 8 is a diagram showing an example of communications between a base station and a group of UEs.

FIG. 9 is a flowchart of an example of a first method (process) for processing a down link transmission by a UE.

FIG. 10 is a flowchart of an example of a second method (process) for processing a down link transmission by a UE.

FIG. 11 is a flowchart of an example of a third method (process) for processing a down link transmission by a UE.

FIG. 12 is a conceptual data flow diagram illustrating an example of the data flow between different components/means in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

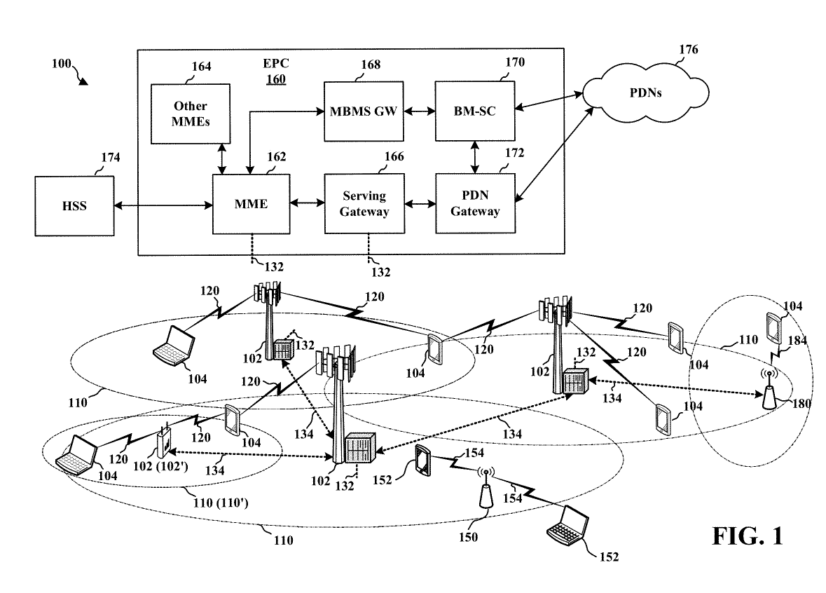

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or down link (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is coupled to the PDN Gateway 172. The PDN Gateway 172 provides UE IP address allocation as well as other functions. The PDN Gateway 172 and the BM-SC 170 are coupled to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, the UE 104 determines, via a CSI component 192, a plurality of messages containing channel state information to be reported to a base station. The UE 104 also determines, via a reporting module 194, a priority level for each of the plurality of messages based on at least one predetermined rule. The UE 104 further selects one or more messages from the plurality of messages based on priority levels of the plurality of messages. The UE 104 then sends the selected one or more messages to the base station.

In certain aspects, the UE 104 determines, via the CSI component 192, a first message and a second message containing channel state information to be reported to a base station. The UE 104 also determines, via the reporting module 194, that a priority level of the first message is higher than a priority level of the second message based on at least one predetermined rule. The UE 104 further maps sets of information bits of the first message to a first plurality of input bits of an encoder and sets of information bits of the second message to a second plurality of input bits of the encoder. The first plurality of input bits offer an error protection level higher than an error protection level offered by the second plurality of input bits.

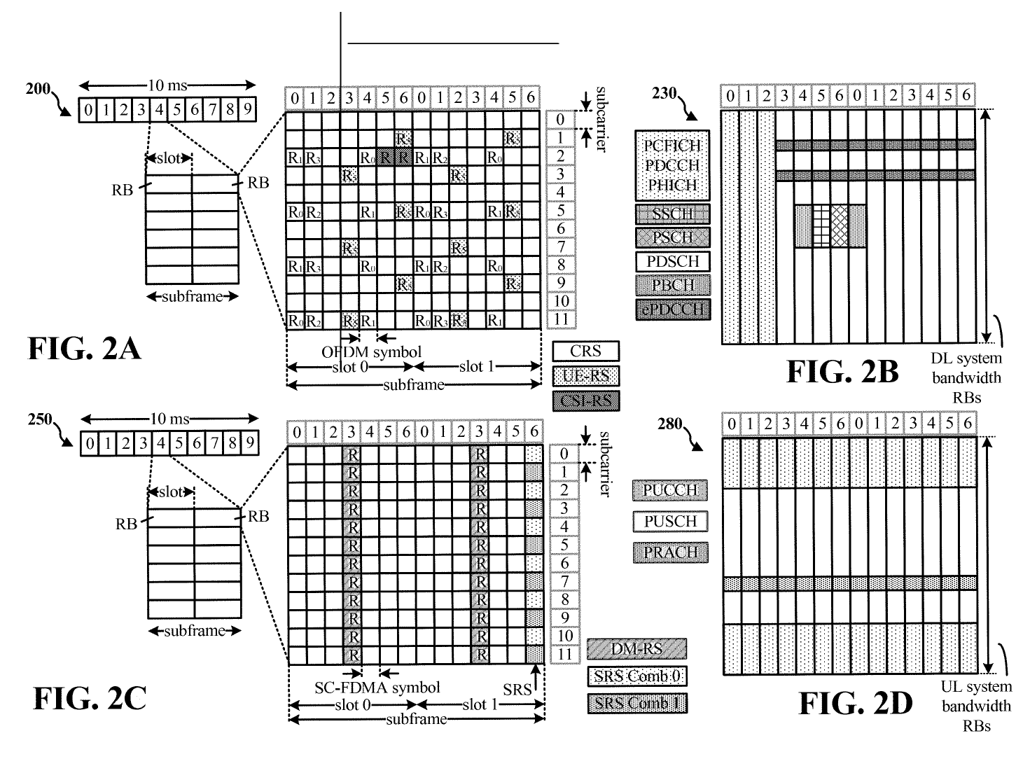

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical down link control channel (PDCCH) occupies 1, 2, or 3 symbols (FIG. 2B illustrates a PDCCH that occupies 3 symbols). The PDCCH carries down link control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical down link shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

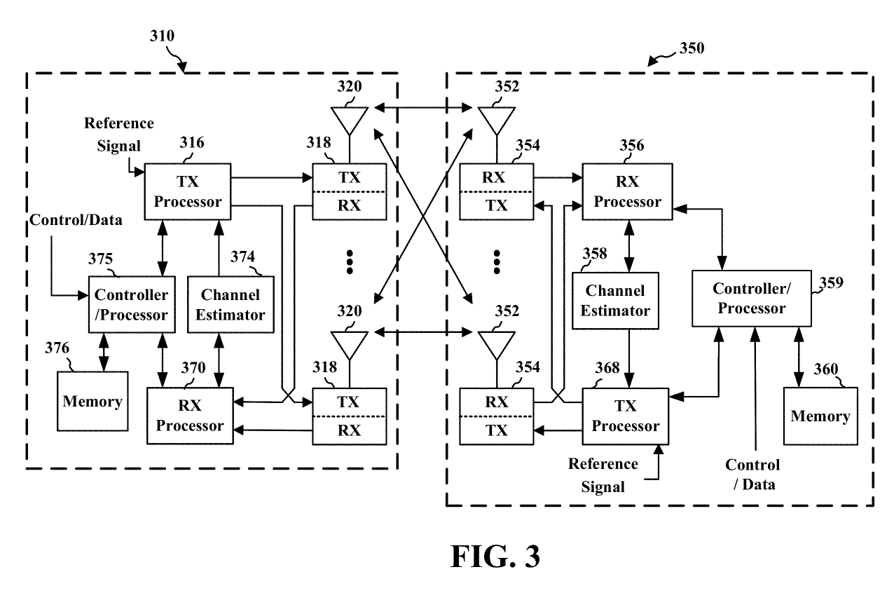

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission. The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and down link and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

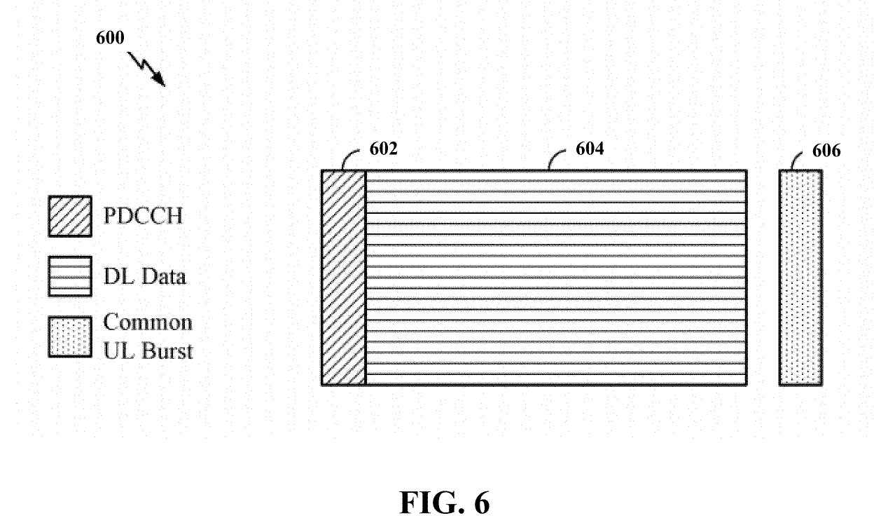

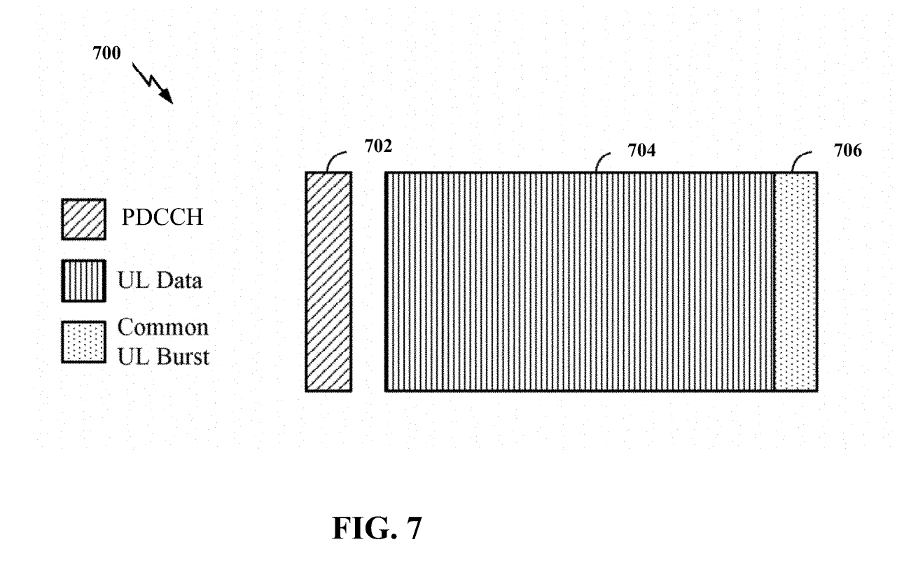

A single component carrier bandwidth of 100 MHZ may be supported. In one example, NR resource blocks (RBs) may span 12 sub-carriers with a sub-carrier bandwidth of 75 kHz over a 0.1 ms duration or a bandwidth of 15 kHz over a 1 ms duration. Each radio frame may consist of 10 or 50 subframes with a length of 10 ms. Each subframe may have a length of 1 ms or 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS); in some cases DCells may transmit SS. NR BSs may transmit down link signals to UEs indicating the cell type. Based on the cell type indication, the UE may communicate with the NR BS. For example, the UE may determine NR BSs to consider for cell selection, access, handover, and/or measurement based on the indicated cell type.

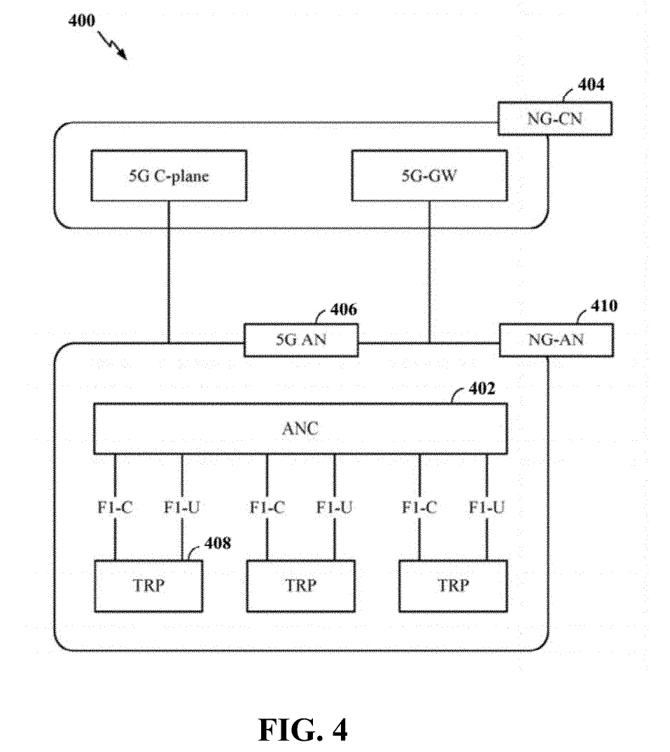

FIG. 4 illustrates an example logical architecture 400 of a distributed RAN, according to aspects of the present disclosure. A 5G access node 406 may include an access node controller (ANC) 402. The ANC may be a central unit (CU) of the distributed RAN 400. The backhaul interface to the next generation core network (NG-CN) 404 may terminate at the ANC. The backhaul interface to neighboring next generation access nodes (NG-ANs) may terminate at the ANC. The ANC may include one or more TRPs 408 (which may also be referred to as BSs, NR BSs, Node Bs, 5G NBs, APs, or some other term). As described above, a TRP may be used interchangeably with “cell.”

The respective TRPs 408 may be a distributed unit (DU). The TRPs may be coupled to one ANC (ANC 402) or more than one ANC (not illustrated). For example, for RAN sharing, radio as a service (RaaS), and service specific AND deployments, the TRP may be coupled to more than one ANC. A TRP may include one or more antenna ports. The TRPs may be configured to individually (e.g., dynamic selection) or jointly (e.g., joint transmission) serve traffic to a UE.

The local architecture of the distributed RAN 400 may be used to illustrate fronthaul definition. The architecture may be defined to support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 410 may support dual connectivity with NR. The NG-AN may share a common fronthaul for LTE and NR.

The architecture may enable cooperation between and among TRPs 408. For example, cooperation may be preset within a TRP and/or across TRPs via the ANC 402. According to aspects, no inter-TRP interface may be needed/present.

According to aspects, a dynamic configuration of split logical functions may be present within the architecture of the distributed RAN 400. The PDCP, RLC, MAC protocol may be adaptably placed at the ANC or TRP.

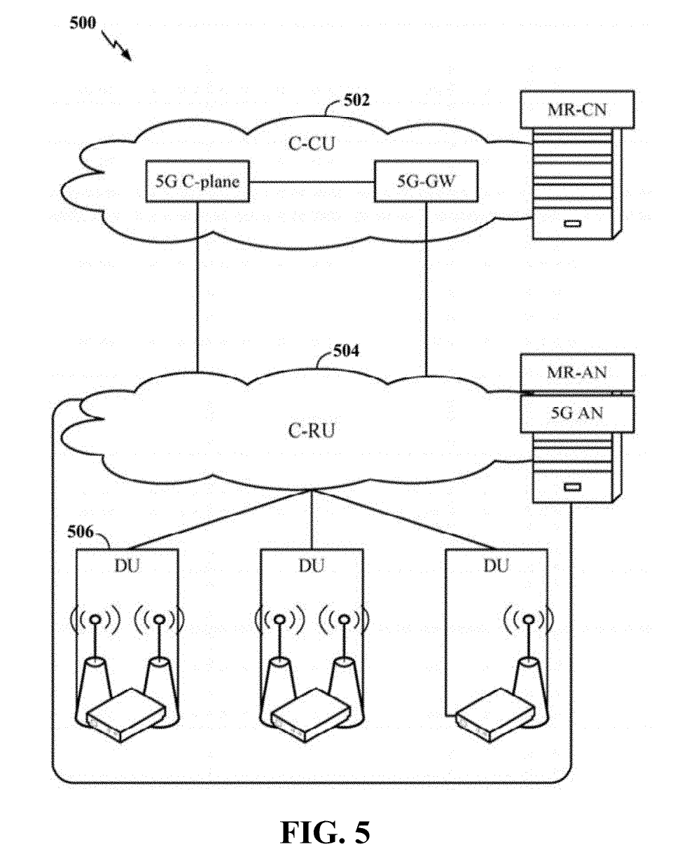

FIG. 5 illustrates an example physical architecture of a distributed RAN 500, according to aspects of the present disclosure. A centralized core network unit (C-CU) 502 may host core network functions. The C-CU may be centrally deployed. C-CU functionality may be offloaded (e.g., to advanced wireless services (AWS)), in an effort to handle peak capacity. A centralized RAN unit (C-RU) 504 may host one or more ANC functions. Optionally, the C-RU may host core network functions locally. The C-RU may have distributed deployment. The C-RU may be closer to the network edge. A distributed unit (DU) 506 may host one or more TRPs. The DU may be located at edges of the network with radio frequency (RF) functionality.

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information.

As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion 602 described above with reference to FIG. 6. The UL-centric subframe may also include an UL data portion 704. The UL data portion 704 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

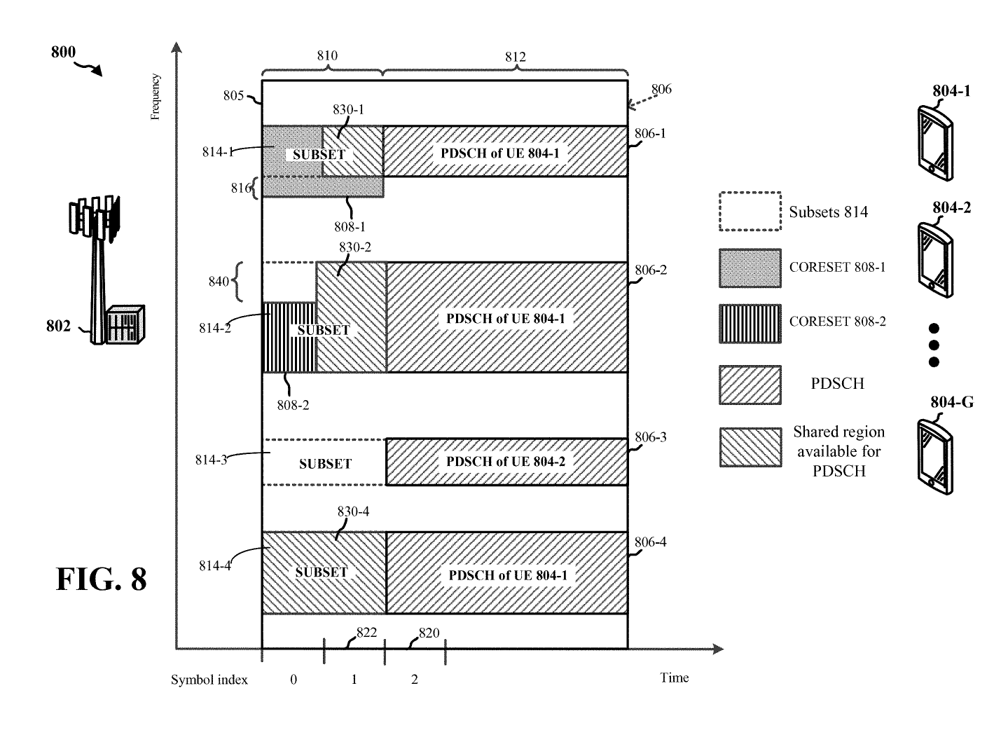

FIG. 8 is a diagram illustrating a communication network 800 in which a base station 802 transmits a down link transmission to one or more UEs of a group that are in a cell of the base station 802, shown as UEs 804-1, 804-2, . . . 804-G, and referred to collectively as UEs 804. G is the number of UEs 804 in the group, without limitation to a particular number G. In the example shown, UEs 804-1, 804-2, . . . 804-G are members of a group. The base station 802 sends down link transmissions to the UEs 804, which can include individual down link transmissions to a particular UE, such as UE 804-1, or a broadcast down link transmission to all of the UEs 804-1, 804-2, . . . 804-G in the group.

In particular, the base station 802 transmits symbols in a downlink time slot 805. The time slot includes a control region 810 and a data region 812. REs in the time slot 805 includes transmission portions 806-1, 806-2, 806-3, 806-4, referred to collectively as transmission portions 806. The transmission portions 806 can occupy a range of frequencies (indicated along the vertical axis), with each transmission portion 806-1, 806-2, 806-3, 806-4 occupies a different frequency sub-range.

In one example, the time slot 805 may contains 7 symbol time periods, as shown in FIGS. 2A and 2B. REs in the transmission portions 806-1, 806-2, 806-3, 806-4 can be allocated to different respective individual UEs of UEs 804-1, 804-2, . . . 804-G, to the same individual UE, and/or to a group of two or more UEs of UEs 804-1, 804-2, . . . 804-G.

Each transmission portion 806 includes a sub-portion in the control region 810 and a sub-portion in the data region 812. The frequency range occupied by a transmission portion 806 is defined by, and is the same as, the frequency range of the PDSCH in that transmission portion 806. The REs in each transmission portion 806 are contiguous in frequency. As described with respect to FIG. 2A, each of control region 810 and data region 812 include multiple REs, wherein each RE spans a symbol and a subcarrier frequency unit. The base station 802 may assign REs in the control region 810 to different control resource sets (CORESETs). One or more CORESETs may be designated to a UE. The base station 802 may transmit a PDCCH specific to a particular UE in a CORESET specific to the particular UE. In the example shown, the control regions 810 of transmission portions 806-1 and 806-2 are configured with CORESETs 808-1 and 808-2 (referred to collectively as CORESETs 808), respectively. Both CORESETs 808-1 and 808-2 may be specific to UE 804-1. The control regions 810 of transmission portions 806-3 and 806-4 are not allocated with a CORESET specific for UE 804-1. For example, any CORESET included in control regions 810 of transmission portions 806-3 and 806-4 may be intended for UEs other than UE 804-1, such as UE 804-2 and a UE 804-6, and is not shown. The PDSCH transmission in data region 812 of transmission portion 806-3 is directed to UE 804-2.

Using the techniques described here, the base station 802 can use REs in the control region 810 for transmission of PDSCH, also referred to as resource sharing between the PDCCH and the PDSCH. The base station 802 can transmit PDSCHs specific to UEs 804-1, 804-2, . . . 804-G into the control region 810. Depending on the technique used, the base station 802 may abide by rules that govern when the PDSCH transmissions can be inserted into a control region 810. Similarly, depending on the technique used and associated conditions, each UE 804 that receives transmissions from the base station 802 can check the control region 810 to obtain PDSCH data.

As described supra, the transmission portions 806-1, 806-2, 806-3, 806-4 each include PDSCH sub-portions in the data region 812. Sub-portions of the transmission portions 806-1, 806-2, 806-3, 806-4 in the control regions 810 are referred to as subsets 814-1, 814-2, 814-3, and 814-4, respectively. That is, subsets 814-1, 814-2, 814-3, and 814-4 are frequency-aligned with the corresponding PDSCH. Depending on the technique used, resource elements in subsets 814-1, 814-2, 814-3, and 814-4 can be used for transmission of PDSCH.

In accordance with certain techniques, the base station 802 can only use REs included in the subsets 814-1, 814-2, 814-3, 814-4 that are frequency aligned with the data portion 812 for insertion of PDSCH transmissions. This restriction can allow reuse of channel estimation, precoder/beamforming and modulation order determinations for REs in the control region 810 that are used for PDSCH transmissions. Additionally, in accordance with certain techniques, the REs in each respective subset 814-1, 814-2, 814-3, and 814-4 are contiguous in frequency in addition to being frequency-aligned with the corresponding data region 812.

In accordance with a first technique, the base station 802 can insert PDSCH data in a subset 814 that is configured with a CORESET 808 (also referred to as having overlapping CORESET 808) that is intended for the same UE 804 of the PDSCH in the same transmission portion.

Accordingly, in the example shown in FIG. 8, some REs of subsets 814-1 and 814-2 are allocated for CORESETs 808-1 and 808-2 specific to UE 804-1. Subsets 814-3 and 814-4 do not have CORESET 808 specific to the UE of the PDSCH in the same transmission portion. When applying the first technique, the base station 802 can share resources between the PDCCH and PDSCH intended for UE 804-1 for transmission portions 806-1 and 806-2, but not for transmission portions 806-3 and 806-4. The base station 802 can decide to use shared regions 830-1 and 830-2 in subsets 814-1 and 814-2 to hold PDSCH data intended for UE 804-1. That is, REs in subsets 814-1 and 814-2 can be shared and are available for holding the PDSCH intended for UE 804-1.

Further, the base station 802 transmits DCI specific to UE 804-1 in at least one of the CORESETS allocated for UE 804-1 (e.g., CORESET 808-2). The DCI includes starting position information, including a first starting position indicator and a second starting position indicator. The first starting position indicator indicates a first starting position 820, which is the initial symbol period of the data region 812. As such, the first starting position 820 also defines a right boundary the subsets 814, completing the definition of the subsets 814. In this example, the first starting position indicator indicates that symbol period 2 is the initial symbol period of the data region 812. The left boundary of each subset 808 is defined by the beginning of the slot and the top and bottom boundaries are defined to be aligned with the frequency range of the corresponding data region 812. The second starting position indicators indicate a second starting position 822, which is the initial symbol period of the shared region 830 for UE 804-1. In this example, the second position indicator indicates that symbol period 1 is the initial symbol period of the shared region 830 for UE 804-1.

FIG. 8 illustrates that PDSCH of UE 804-1 in the data region 812 begins at first starting position 820. The right boundary of each of subsets 814-2, 814-2, 814-3, and 814-4 is defined by the first starting position 820. The second starting position 822 defines a left boundary of the shared region 830-1 and the shared region 830-2. Right, top, and bottom boundaries of shared region 830-2 are defined by the right, top, and bottom boundaries of subset 814-2.

According to the first technique, since subsets 814-3 and 814-4 are not overlapped by a CORESET 808 allocated to UE 804-1, subsets 814-3 and 814-4 are not provided with a shared region and do not share their resources for PDSCH transmission.

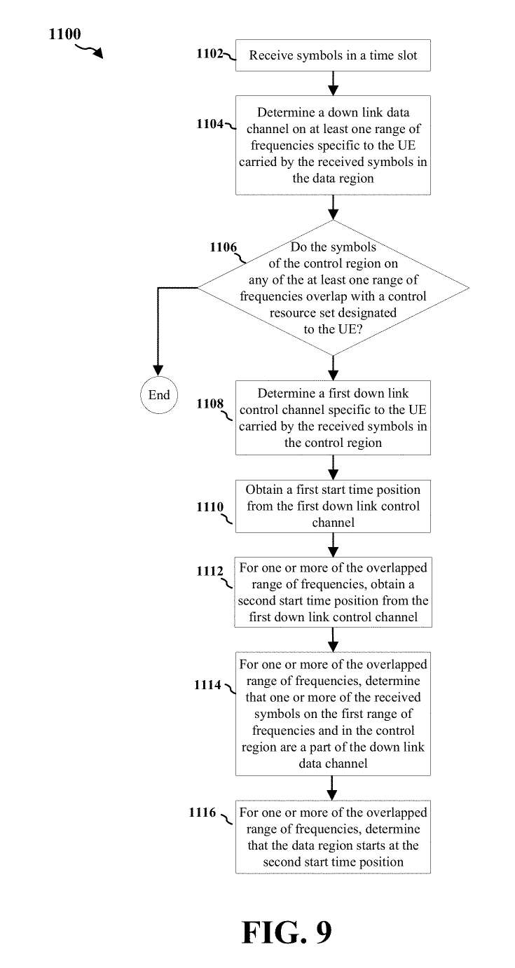

The base station 802 can use the REs in shared regions 830-1 and 830-2 to hold PDSCH during transmission. In other words, when UE 804-1 receives a down link transmission from the base station 802, UE 804-1 needs to know when a shared region 830 is available to be used, the boundaries of any shared regions determined available to be used, and to access any PDSCH transmitted in these shared regions 830. Operations of UE 804-1 in accordance with the first technique are described with respect to FIG. 9.

In an example illustrating application of the first technique, UE 804-1 receives symbols in the time slot 805, which includes the transmission portions 806-1 . . . 806-4. In this example, UE 804-1 determines that transmission portions 806-1, 806-2, and 806-4 in the data region 812 include PDSCH specific to UE 804-1.

The UE 804-1 determines whether CORESET designated for UE 804-1 overlaps with any of the transmission portion 806-1, 806-2, and 806-4. If the CORESET does not overlap a transmission portion 806, UE 804-1 determines that transmission portion 806 in the control region 810 does not contain a shared region.

As illustrated in the example shown, UE 804-1 is able to determine that there are CORESETs for UE 804-1 that overlap with transmission portions 806-1 and 806-2. UE 804-1 can locate and access DCI in one or more CORESETs to obtain the starting position information. The UE 804-1 determines the first starting position 820 and the second starting position 822 indicated by the starting position information. Using the first starting position 820, UE 804-1 determines the start of the data region 812.

The UE 804-1 can determine that a PDSCH of transmission portions 806-1, 806-2 can potentially effectively extend into the control region 810. More specifically, the PDSCH starts at the second starting position 822 in the control region 810.

In accordance with the second technique, the base station 802 can share resources in the control region 810 between PDCCH and PDSCH when the PDSCH in the data region 812 is intended for UE 804-1, even when a subset 814 is not overlapped with a CORESET 808 allocated for UE 804-1. The PDSCH of the fourth transmission potion 806-4 is intended for UE 804-1. Even though the control region 810 of transmission portion 806-4 does not include CORESET for UE 804-1, the base station 802 can share resources and insert PDSCH intended for UE 804-1 in a shared region 830-4 of that control region 810 of transmission portion 806-4.

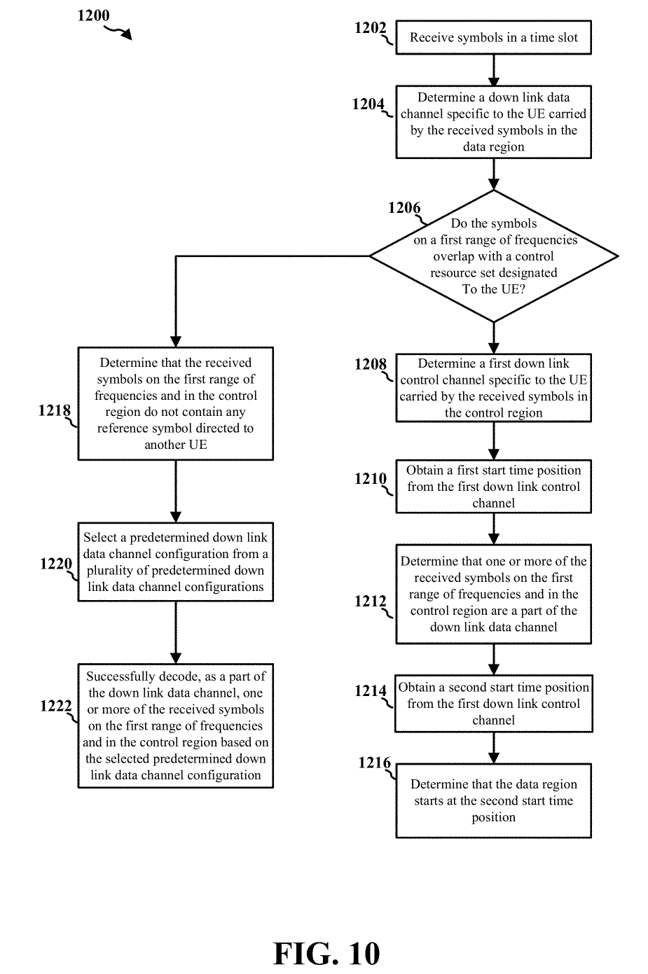

The base station 802 can use the REs in shared regions 830-1, 830-2, and 830-4 to hold PDSCH during transmission. In other words, when UE 804-1 receives a down link transmission from the base station 802, UE 804-1 needs to know when a shared region 830 is available to be used, the boundaries of any shared regions determined as available to be used, and to access any PDSCH transmitted in these shared regions 830. Operations of UE 804-1 in accordance with the second technique are described with respect to FIG. 10.

In an example illustrating application of the second technique, UE 804-1 receives symbols in the time slot 805, which includes the transmission portions 806-1 . . . 806-4. In this example, UE 804-1 determines that transmission portions 806-1, 806-2, and 806-4 in the data region 812 include PDSCH specific to UE 804-1.

UE 804-1 uses the first technique described supra to determine the shared regions 830-1, 830-2. As for transmission portion 806-4 that was determined to not overlap with a CORESET for UE 804-1, UE 804-1 can use energy detection to determine whether the PDCCH transmitted using the control region 810 of transmission portion 806-4 includes PDCCH directed to another UE (i.e., any of UEs 804-2 . . . 804-G). In particular, UE 804-1 detects energy of demodulation reference signals (DMRSs) specific to other UEs in each REG of the subset 814-4.

If there is no DMRS detected in any REG, UE determines that the subset 814-4 may be used by the base station 802 for PDSCH of UE 804-1. UE 804-1 can determine, or is configured with, hypotheses of possible PDSCH locations in the subset 814-4. For each hypothesis, UE 804-1 performs channel decoding (including de-rate matching) for code blocks corresponding to the PDSCH locations in that hypothesis and check the CRC. If the CRC check succeeds, UE 804-1 knows that PDSCH locations in that hypothesis are correct and, accordingly, obtains PDSCH data from the shared resources.

In order to reduce the number of blind detections performed, UE 804-1 can further select a predetermined PDSCH configuration from multiple predetermined PDSCH configurations. In particular, the hypothetical set of code blocks can be restricted. For example, the predetermined PDSCH configuration can restrict the shared region 830-4, and thus the hypothetical set of code blocks, to particular symbols in time domain, such as {symbol 0}, {symbol 1}, and {symbol 0, symbol 1}. In this way, UE 804-1 can perform a reduced number of blind detections to successfully decode PDSCH that was transmitted within the subset 814-4.

In accordance with the third technique, the base station 802 can share resources between the PDCCH and the PDSCH potentially in any subset 814. In this technique, the base station 802 provides resource allocation information in the GC PDCCH. The GC PDCCH indicates resource allocation of PDCCHs of all the UEs in the group. For example, the resource allocation information can be carried by a bitmap. In an example, the control region 810 is predetermined and divided into eight sub-regions (SR0, SR1, SR2, SR3, SR4, SR5, SR6, SR7) in the frequency domain. The resource allocation information includes a bitmap [1 1 1 1 0 0 0 0], indicating that SR0-SR3 are occupied by PDCCHs of the group of UEs and SR4-SR7 are not occupied by PDCCHs. Each of the subsets 814 is a respective sub-region.

In the example shown, UE 804-1 can use the resource allocation information and the starting position information to determine which transmission portions 806 can be used for inserting PDSCH transmissions intended for UE 804-1. UE 804-1 thus knows in which sub-regions to locate and receive the data that the base station 802 has transmitted to UE 804-1.

In an example illustrating application of the third technique, the subset 814-4 is SR4. UE 804-1 receives the bitmap from the GC-PDCCH and learns that the subset 814-1 (i.e., SR4) is not occupied by a PDCCH of another UE. Thus, UE 804-1 determines that the subset 814-4 may contain PDSCH of UE 804-1, as the transmission portion 806-4 contains PDSCH of UE 804-1 in the data region 812.

UE 804-1 further obtains PDCCH specific to UE 804-1 and obtains starting position information indicated by DCI carried by PDCCH. UE 804-1 determines a first starting position 820 as indicated by a first starting position indicator of the starting position information. As described supra, the first starting position indicator indicates the initial symbol period of the data region 812. Further, using the blind decoding operations described with respect to the second technique, UE 804-1 can locate and decode PDSCH carried in the subset 814-04, if any, that is specific to UE 804-1.

FIG. 9 is a flowchart 1100 of a method (process) in accordance with the first technique for processing a down link transmission, such as transmission portions 806 shown in FIG. 8. The method is performed by a UE 804-1 of a group of UEs 804-1, 804-2, . . . 804-G, apparatus 1402, and apparatus 1402′. At operation 1102, the UE receives symbols in a time slot, the time slot including a control region and a data region. At operation 1104, the UE determines a down link data channel specific to the UE carried by the received symbols in the data region. The down link data channel is on at least one range of frequencies. At operation 1106, the UE determines whether symbols of any of the at least one range of frequencies and in the control region overlap with a control resource set designated to the UE. If the determination at operation 406 is that the symbols on one or more ranges of frequencies do overlap with a control resource set designated to the UE, the method continues at operation 1108. If the determination at operation 406 is that the symbols on each of the ranges do not overlap with a control resource set designated to the UE, the method ends.

At operation 1108, the UE determines a first down link control channel specific to the UE carried by the received symbols in the control region. At operation 1110, the UE obtains a first start time point from the first down link control channel. At operation 1112, for one or more of the overlapped range of frequencies, the UE obtains a second start time point from the first down link control channel. At operation 1114, for one or more of the overlapped range of frequencies, the UE determines that one or more of the received symbols on the first range of frequencies and in the control region are a part of the down link data channel. At operation 1116, for the one or more of the overlapped range of frequencies, the UE determines that the data region starts at the second start time point. In other words, the UE has determined that one or more of the received symbols on the at least one range of frequencies and in the control region are a part of the down link data channel and has further determined the location of these symbols.

In accordance with configurations, determining that one or more of the received symbols on the first range of frequencies and in the control region are a part of the down link data channel includes determining that the received symbols at and after the first start time point in the control region and on the first range of frequencies are a part of the down link data channel.

FIG. 10 is a flowchart 1200 of a method (process) in accordance with the second technique for processing a down link transmission, such as transmission portions 806 shown in FIG. 9. The method is performed by a UE 804-1 of a group of UEs 804-1, 804-2, . . . 804-G, apparatus 1402, and apparatus 1402′. At operation 1202, the UE receives symbols in a time slot, the time slot including a control region and a data region. At operation 1204, the UE determines a down link data channel specific to the UE carried by the received symbols in the data region. The down link data channel is on at least one range of frequencies. At operation 1206, the UE determines whether symbols on a first range of the at least one range of frequencies and in the control region overlap with a control resource set designated to the UE. If the determination at operation 406 is that the symbols on the first range do overlap with a control resource set designated to the UE, the method continues at operation 1208. If the determination at operation 406 is that the symbols on the first range do not overlap with a control resource set designated to the UE, the method continues at operation 1218.

At operation 1208, the UE determines a first down link control channel specific to the UE carried by the received symbols in the control region. At operation 1210, the UE obtains a first start time point from the first down link control channel. At operation 1212, the UE obtains a second start time point from the first down link control channel. At operation 1214, the UE determines that one or more of the received symbols on the first range of frequencies and in the control region are a part of the down link data channel, which includes determining that the received symbols at and after the first start time point in the control region and on the first range of frequencies are a part of the down link data channel. At operation 1216, the UE determines that the data region starts at the second start time point. In other words, the UE has determined that one or more of the received symbols on the at least one range of frequencies and in the control region are a part of the down link data channel and has further determined the location of these symbols.

At operation 1218, the UE determines that the received symbols on the first range of frequencies and in the control region do not contain any reference symbol directed to another UE (such as UEs 804-2 . . . 804-G). At operation 1220, the UE selects a predetermined down link data channel configuration from a plurality of predetermined down link data channel configurations. At operation 1222, the UE successfully decodes, as a part of the down link data channel, one or more of the received symbols on the first range of frequencies and in the control region based on the selected predetermined down link data channel configuration.

In accordance with configurations, determining that one or more of the received symbols on the first range of frequencies and in the control region are a part of the down link data channel includes determining that the received symbols at and after the first start time point in the control region and on the first range of frequencies are a part of the down link data channel.

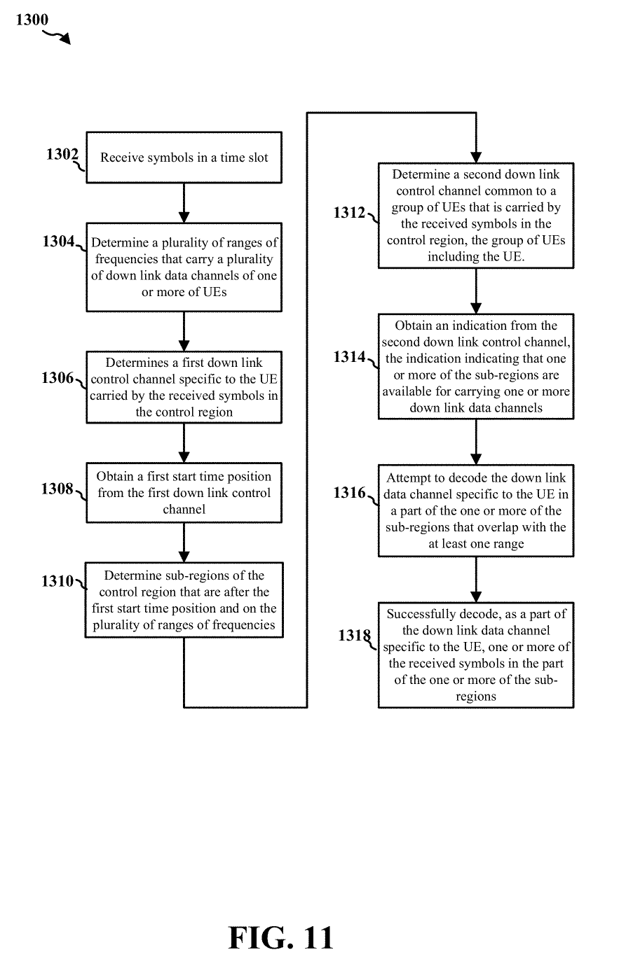

FIG. 11 is a flowchart 1300 of a method (process) in accordance with the third technique for processing a down link transmission, such as transmission portions 806 shown in FIG. 10. The method is performed by a UE 804-1 of a group of UEs 804-1, 804-2, . . . 804-G, apparatus 1402, and apparatus 1402′. At operation 1302, the UE receives symbols in a time slot, the time slot including a control region and a data region. At operation 1304, the UE determines a down link data channel specific to the UE carried by the received symbols in the data region. The down link data channel is on at least one range of frequencies. At operation 1306, the UE determines a plurality of ranges of frequencies that carry a plurality of down link data channels of one or more of UEs, the plurality of ranges of frequencies including the at least one range of frequencies. At operation 1308, the UE determines a first down link control channel specific to the UE carried by the received symbols in the control region.

At operation 1310, the UE obtains a first start time point from the first down link control channel. At operation 1312, the UE determines sub-regions of the control region that are after the first start time point and on the plurality of ranges of frequencies. At operation 1314, the UE determines a second down link control channel common to a group of UEs that is carried by the received symbols in the control region, the group of UEs including the UE. At operation 1316, the UE obtains an indication from the second down link control channel, the indication indicating that one or more of the sub-regions are available for carrying one or more down link data channels. At operation 1318, the UE attempts to decode the down link data channel specific to the UE in a part of the one or more of the sub-regions that overlap with the at least one range. At operation 1320, the UE successfully decodes, as a part of the down link data channel specific to the UE, one or more of the received symbols in the part of the one or more of the sub-regions.

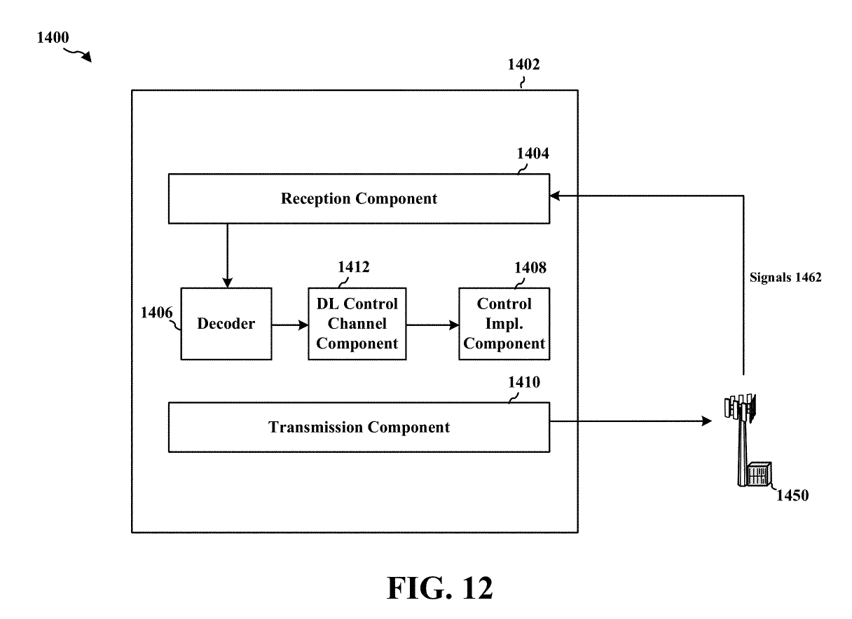

FIG. 12 is a conceptual data flow diagram 1400 illustrating the data flow between different components/means in an exemplary apparatus 1402. The apparatus 1402 may be a UE. The apparatus 1402 includes a reception component 1404, a decoder 1406, a control implementation component 1408, an energy detection component 1410, an energy down link channel component 1412, and a transmission component 1414. The reception component 1404 may receive transmission signals 1462 including symbols in a time slot, the time slot including a control region and a data region from a base station 1450.

In one aspect, the down link channel component 1412 determines a down link data channel specific to the UE carried by the received symbols in the data region. The down link data channel is on at least one range of frequencies. The down link channel component 1412 determines whether symbols on a first range of the at least one range of frequencies and in the control region overlap with a control resource set designated to the UE.

If the down link channel component determines that the symbols on the first range do overlap with a control resource set designated to the UE, then, the down link channel component 1412 determines a first down link control channel specific to the UE carried by the received symbols in the control region. The decoder 1406 obtains a first start time point from the first down link control channel. The down link channel component determines that one or more of the received symbols on the first range of frequencies and in the control region are a part of the down link data channel. In certain configurations, down link channel component can determine that the received symbols at and after the first start time point in the control region and on the first range of frequencies are a part of the down link data channel.

The decoder 1406 obtains a second start time point from the first down link control channel. The down link channel component 1412 determines that the data region starts at the second start time point. In accordance with certain configurations, the down link channel component 1412 can determine that one or more of the received symbols on the at least one range of frequencies and in the control region are a part of the down link data channel and has further determined the location of these symbols.

If the down link channel component determines that the symbols on the first range do not overlap with a control resource set designated to the UE, then, the processing the received transmission signals ends.

In one aspect, the down link channel component 1412 determines a down link data channel specific to the UE carried by the received symbols in the data region. The down link data channel is on at least one range of frequencies. The down link channel component 1412 determines whether symbols on a first range of the at least one range of frequencies and in the control region overlap with a control resource set designated to the UE.

If the down link channel component determines that the symbols on the first range do overlap with a control resource set designated to the UE, then, the down link channel component 1412 determines a first down link control channel specific to the UE carried by the received symbols in the control region. The decoder 1406 obtains a first start time point from the first down link control channel. The down link channel component determines that one or more of the received symbols on the first range of frequencies and in the control region are a part of the down link data channel. In certain configurations, down link channel component can determine that the received symbols at and after the first start time point in the control region and on the first range of frequencies are a part of the down link data channel.

The decoder 1406 obtains a second start time point from the first down link control channel. The down link channel component 1412 determines that the data region starts at the second start time point. In accordance with certain configurations, the down link channel component 1412 can determine that one or more of the received symbols on the at least one range of frequencies and in the control region are a part of the down link data channel and has further determined the location of these symbols.

If the down link channel component determines that the symbols on the first range do not overlap with a control resource set designated to the UE, then, the down link channel component 1412 determines that the received symbols on the first range of frequencies and in the control region do not contain any reference symbol directed to another UE (such as UEs 804-2 . . . 804-G shown in FIG. 8). The down link channel component selects a predetermined down link data channel configuration from a plurality of predetermined down link data channel configurations. The decoder 1406 successfully decodes, as a part of the down link data channel, one or more of the received symbols on the first range of frequencies and in the control region based on the selected predetermined down link data channel configuration.

In one aspect, the down link channel component determines a down link data channel specific to the UE carried by the received symbols in the data region. The down link data channel is on at least one range of frequencies. The down link channel component determines a plurality of ranges of frequencies that carry a plurality of down link data channels of one or more of UEs, the plurality of ranges of frequencies including the at least one range of frequencies. The down link channel component determines a first down link control channel specific to the UE carried by the received symbols in the control region.

The decoder 1406 obtains a first start time point from the first down link control channel. The down link channel component determines sub-regions of the control region that are after the first start time point and on the plurality of ranges of frequencies. The down link channel component determines a second down link control channel common to a group of UEs that is carried by the received symbols in the control region, the group of UEs including the UE. The decoder 1406 obtains an indication from the second down link control channel, the indication indicating that one or more of the sub-regions are available for carrying one or more down link data channels. The decoder 1406 attempts to decode the down link data channel specific to the UE in a part of the one or more of the sub-regions that overlap with the at least one range. In configurations, the decoder 1406 successfully decodes, as a part of the down link data channel specific to the UE, one or more of the received symbols in the part of the one or more of the sub-regions.

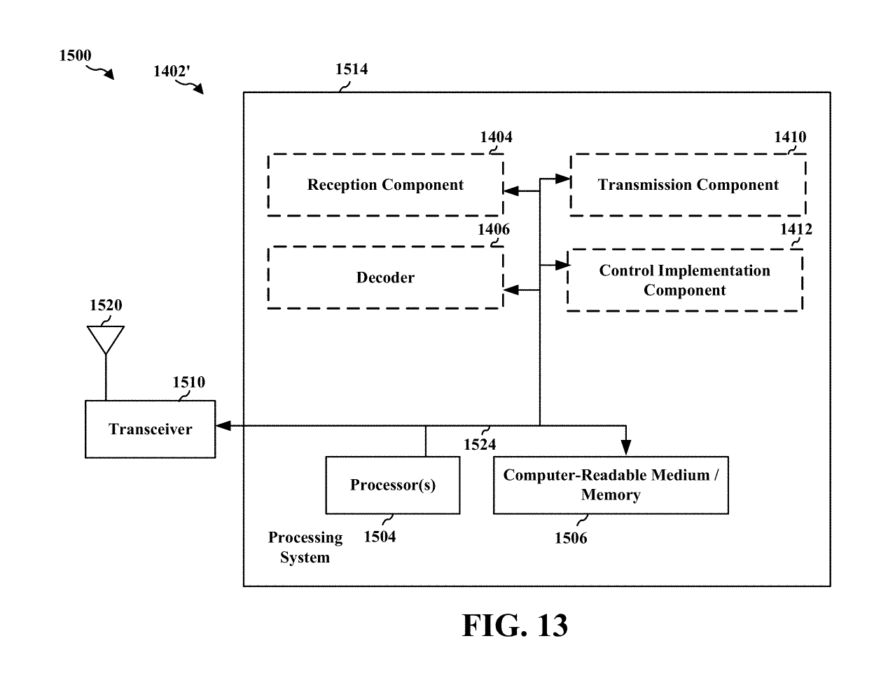

FIG. 13 is a diagram 1500 illustrating an example of a hardware implementation for an apparatus 1402′ employing a processing system 1514. The processing system 1514 may be implemented with a bus architecture, represented generally by a bus 1524. The bus 1524 may include any number of interconnecting buses and bridges depending on the specific application of the processing system 1514 and the overall design constraints. The bus 1524 links together various circuits including one or more processors and/or hardware components, represented by one or more processors 1504, the reception component 1404, the decoder 1406, the control implementation component 1408, the energy detection component 1410, the energy down link channel component 1412, a transmission component 1414, and a computer-readable medium/memory 1506. The bus 1524 may also link various other circuits such as timing sources, peripherals, voltage regulators, and power management circuits, etc.

The processing system 1514 may be coupled to a transceiver 1510, which may be one or more of the transceivers 354. The transceiver 1510 is coupled to one or more antennas 1520, which may be the communication antennas 352.

The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1414, and based on the received information, generates a signal to be applied to the one or more antennas 1520.

The processing system 1514 includes one or more processors 1504 coupled to a computer-readable medium/memory 1506. The one or more processors 1504 are responsible for general processing, including the execution of software stored on the computer-readable medium/memory 1506. The software, when executed by the one or more processors 1504, causes the processing system 1514 to perform the various functions described supra for any particular apparatus. The computer-readable medium/memory 1506 may also be used for storing data that is manipulated by the one or more processors 1504 when executing software. The processing system 1514 further includes at least one of the reception component 1404, the decoder 1406, the control implementation component 1408, the energy detection component 1410, the energy down link channel component 1412, and a transmission component 1414. The components may be software components running in the one or more processors 1504, resident/stored in the computer readable medium/memory 1506, one or more hardware components coupled to the one or more processors 1504, or some combination thereof. The processing system 1514 may be a component of the UE 804 and may include the memory 360 and/or at least one of the TX processor 368, the RX processor 356, and the controller/processor 359.

In one configuration, the apparatus 1402/apparatus 1402′ for wireless communication includes means for performing each of the operations of FIGS. 9-11. The aforementioned means may be one or more of the aforementioned components of the apparatus 1402 and/or the processing system 1514 of the apparatus 1402′ configured to perform the functions recited by the aforementioned means. As described supra, the processing system 1514 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving symbols in a time slot, the time slot including a control region and a data region;
determining a down link data channel specific to the UE carried by the received symbols in the data region, the down link data channel being on at least one range of frequencies; and
determining that one or more of the received symbols on the at least one range of frequencies and in the control region are a part of the down link data channel.

2. The method of claim 1, wherein the determining that the one or more of the received symbols are a part of the down link data channel comprises:
determining that symbols on a first range of the at least one range of frequencies and in the control region overlap with a control resource set designated to the UE; and
determining that one or more of the received symbols on the first range of frequencies and in the control region are a part of the down link data channel.

3. The method of claim 2, further comprising:
determining a first down link control channel specific to the UE carried by the received symbols in the control region; and
obtaining a first start time point from the first down link control channel, wherein the determining that one or more of the received symbols on the first range of frequencies and in the control region are a part of the down link data channel comprises:
determining that the received symbols at and after the first start time point in the control region and on the first range of frequencies are a part of the down link data channel.

4. The method of claim 3, further comprising:
obtaining a second start time point from the first down link control channel; and
determining that the data region starts at the second start time point.

5. The method of claim 1, wherein the determining that one or more of the received symbols are a part of the down link data channel comprises:
determining that symbols on a first range of the at least one range of frequencies and in the control region do not overlap with any control resource set designated to the UE; and
successfully decoding, as a part of the down link data channel, one or more of the received symbols on the first range of frequencies and in the control region based on a predetermined down link data channel configuration.

6. The method of claim 5, further comprising selecting the predetermined down link data channel configuration from a plurality of predetermined down link data channel configurations.

7. The method of claim 5, further comprising:
prior to successfully decoding the one or more of the received symbols, determining that the received symbols on the first range of frequencies and in the control region do not contain any reference symbol directed to another UE.

8. The method of claim 1, further comprising:
determining a plurality of ranges of frequencies that carry a plurality of down link data channels of one or more of UEs, the plurality of ranges of frequencies including the at least one range of frequencies;
determining a first down link control channel specific to the UE carried by the received symbols in the control region;
obtaining a first start time point from the first down link control channel; and
determining sub-regions of the control region that are after the first start time point and on the plurality of ranges of frequencies.

9. The method of claim 8, further comprising:
determining a second down link control channel common to a group of UEs that is carried by the received symbols in the control region, the group of UEs including the UE;
obtaining an indication from the second down link control channel, the indication indicating that one or more of the sub-regions are available for carrying one or more down link data channels; and
attempting to decode the down link data channel specific to the UE in a part of the one or more of the sub-regions that overlap with the at least one range.

10. The method of claim 9, further comprising:
successfully decoding, as a part of the down link data channel specific to the UE, one or more of the received symbols in the part of the one or more of the sub-regions.

11. A user equipment (UE) of a wireless communication system, comprising:
a memory; and
at least one processor coupled to the memory and configured to:
receive symbols in a time slot, the time slot including a control region and a data region;
determine a down link data channel specific to the UE carried by the received symbols in the data region, the down link data channel being on at least one range of frequencies; and
determine that one or more of the received symbols on the at least one range of frequencies and in the control region are a part of the down link data channel.

12. The UE of claim 11, wherein when determining that the one or more of the received symbols are a part of the down link data channel, the at least one processor is further configured to:
determine that symbols on a first range of the at least one range of frequencies and in the control region overlap with a control resource set designated to the UE; and
determine that one or more of the received symbols on the first range of frequencies and in the control region are a part of the down link data channel.

13. The UE of claim 12, wherein the at least one processor is further configured to:
determine a first down link control channel specific to the UE carried by the received symbols in the control region; and
obtain a first start time point from the first down link control channel, wherein the determining that one or more of the received symbols on the first range of frequencies and in the control region are a part of the down link data channel comprises:
determine that the received symbols at and after the first start time point in the control region and on the first range of frequencies are a part of the down link data channel.

14. The UE of claim 13, wherein the at least one processor is further configured to:
obtain a second start time point from the first down link control channel; and
determine that the data region starts at the second start time point.

15. The UE of claim 11, wherein when determining that one or more of the received symbols are a part of the down link data channel, the at least one processor is further configured to:
determine that symbols on a first range of the at least one range of frequencies and in the control region do not overlap with any control resource set designated to the UE; and
successfully decode, as a part of the down link data channel, one or more of the received symbols on the first range of frequencies and in the control region based on a predetermined down link data channel configuration.

16. The UE of claim 15, wherein the at least one processor is further configured to select the predetermined down link data channel configuration from a plurality of predetermined down link data channel configurations.

17. The UE of claim 15, wherein the at least one processor is further configured to:
prior to successfully decoding the one or more of the received symbols, determine that the received symbols on the first range of frequencies and in the control region do not contain any reference symbol directed to another UE.

18. The UE of claim 11, wherein the at least one processor is further configured to:
determine a plurality of ranges of frequencies that carry a plurality of down link data channels of one or more of UEs, the plurality of ranges of frequencies including the at least one range of frequencies;
determine a first down link control channel specific to the UE carried by the received symbols in the control region;
obtain a first start time point from the first down link control channel; and
determine sub-regions of the control region that are after the first start time point and on the plurality of ranges of frequencies.

19. The UE of claim 18, wherein the at least one processor is further configured to:
determine a second down link control channel common to a group of UEs that is carried by the received symbols in the control region, the group of UEs including the UE;
obtain an indication from the second down link control channel, the indication indicating that one or more of the sub-regions are available for carrying one or more down link data channels;
attempt to decode the down link data channel specific to the UE in a part of the one or more of the sub-regions that overlap with the at least one range; and
successfully decode, as a part of the down link data channel specific to the UE, one or more of the received symbols in the part of the one or more of the sub-regions.

20. A computer-readable medium storing computer executable code for a wireless communication system including a user equipment (UE), comprising code to:
receive symbols in a time slot, the time slot including a control region and a data region;
determine a down link data channel specific to the UE carried by the received symbols in the data region, the down link data channel being on at least one range of frequencies; and
determine that one or more of the received symbols on the at least one range of frequencies and in the control region are a part of the down link data channel.
